(19) United States
(12) Patent Application Publication
(10) Pub. No.: US 2008/0192991 A1
(43) Pub. Date: Aug. 14, 2008

(54) Magnetic Resonance Imaging at Several Rf Frequencies

(75) Inventors: Felix Gremse, Aachen (DE); Vasanth Philomin, Stolberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/908,443

(22) PCT Filed: Mar. 15, 2006
(86) PCT No.: PCT/IB06/50811

§ 371 Date: Sep. 12, 2007

(30) Foreign Application Priority Data
Mar. 18, 2005 (EP) 05102188.9

(51) Int. Cl. G06K 9/00

(52) U.S. Cl. 382/118

(57) ABSTRACT

The invention describes a method of performing face recognition, which method comprises the steps of generating an average face model (M_{AV})—comprising a matrix of states representing regions of the face—from a number of distinct face images (I₁, I₂, . . . Iⱼ) and training a reference face model (M₁, M₂, . . . , Mₙ) for each one of a number of known faces, where the reference face model (M₁, M₂, . . . , Mₙ) is based on the average face model (M_{AV}). A test image (I_{T}) is acquired for a face to be identified, and a best path through the average face model (MAv) is calculated, based on the test image (I_{T}). A degree of similarity is evaluated for each reference face model (M₁, M₂, . . . , Mₙ) against the test image (I_{T}) by applying the best path of the average face model (M_{AV}) to each reference face model (M₁, M₂, . . . , Mₙ) to identify the reference face model (M₁, M₂, . . . , Mₙ) most similar to the test image (I_{T}), which identified reference face mod el (M₁, M₂, . . . , Mₙ) is subsequently accepted or rejected on the basis of its degree of similarity. Furthermore, the invention describes a system for performing face recognition. Also, the invention describes a method of and system for training a reference face model (M₁) which may be used in the face recognition system, a method of and system for calculating a similarity threshold value for a reference face model (Mₙ) which may be used in the face recognition system, and a method of and system for optimizing images (I, I_{T}, I_{T}, G₁, G₂, . . . G, T₁, T₂, . . . , Tm, Tnew) which may be used in the face recognition system.

The invention relates to a method of performing face recognition, and to a system for performing face recognition.

Applications involving face recognition are often associated with security systems, in which face recognition technology is used to decide whether a person is to be granted or denied access to the system, or surveillance systems, which are used to identify or track a certain individual. Other applications which are becoming more widespread include those of identifying users of dialog systems, such as home dialog systems, or image searching applications for locating a specific face in a video or photo archive, or finding a certain actor in a movie or other recorded video sequence.

Any face recognition technique is based on models of faces. A database of face models is generally used, against which a probe image is compared to find the closest match. For example, a person wishing to gain entry to a system such as a building may first have to undergo a face recognition step in which it is attempted to match an image of his face to a face model in a security databank in order to determine whether the person is to be permitted or denied access. A model of a face is built or trained using information obtained from images, usually a number of images of the same face, all taken under slightly different circumstances such as different lighting or different posture.

US2004/0071338 A1 suggests training a model for each person separately with respect to the Maximum Likelihood (ML) criterion. This is a well-known technique used for training models for many face recognition applications. In its approach to face recognition, US2004/0071338 determines the closest model for a given probe image, or image of a face, but fails to cover the eventuality that the probe image originates from an unknown person, leaving open the possibility that an unknown person could gain access to a system protected by this approach. Another disadvantage of this system is that the recognition process is quite time-consuming, so that a person has to wait for a relatively long time before the face recognition system has come up with an identification result. The reason for the long delay is that, in order to determine the likelihood that a model of the database represents the same face as that in the probe image, it is necessary to carry out time-intensive computations for each model in the database in order to decide which model most closely resembles the person being subject to the identification procedure. However, in most face recognition systems, it is desirable that the face recognition to be completed as quickly as possible, since any perceived time delay will annoy the user.

Furthermore, it is unfortunately often the case that the conditions under which the probe image is captured may be less than ideal. Apart from being unable to precisely control the aspect at which the user faces the camera, or the facial expression he assumes, varying illumination conditions lead to the same face appearing differently in different images. A face recognition system used for real application has to function in such an unconstrained environment.

Overall, it remains a problem that the entire face recognition process is often too slow und too inaccurate, i.e., that many face recognition systems exhibit unsatisfactory behaviour.

Therefore, an object of the present invention is to provide a faster and more accurate way of performing face recognition.

To this end, the present invention provides a method of performing face recognition, which method comprises the steps of generating an average face model—comprising a matrix of states representing regions of the face—from a number of distinct face images, and training a reference face model for each one of a number of known faces, where the reference face model is based on the average face model. Therefore, the reference face model is compatible with the average face model. The method further comprises the steps of acquiring a test image for a face to be identified, calculating a best path through the average face model based on the test image, evaluating a degree of similarity for each reference face model against the test image by applying the best path of the average face model to each reference face model, identifying the reference face model most similar to the test image, and accepting or rejecting the identified reference face model on the basis of the degree of similarity.

An appropriate system for performing face recognition comprises a number of reference face models and an average face model where each face model comprises a matrix of states representing regions of the face, an acquisition unit for acquiring a test image, and a best path calculator for calculating a best path through the average face model. The system further comprises an evaluation unit for applying the best path of the average face model to each reference face model in order to evaluate a degree of similarity between each reference face model and the test image. To decide whether to accept or reject the reference face model with the greatest degree of similarity, the system comprises a decision-making unit.

A face model for use in the invention is specifically a statistical model composed of a matrix of states, each of which represents a region of a face, so that one particular state can be associated with a local facial feature such as an ear, an eye, an eyebrow, or a part of a facial feature. Each state comprises, for example, a Gaussian mixture model for modelling the probability of a local feature vector given the local facial region. A linear sequence of such states can be modelled using a type of statistical model known as the hidden Markov model (HMM). However, since a facial image is a two-dimensional image, in which each row can be seen as a linear state sequence, the statistical model used in the present invention is preferably a two-dimensional model, such as a pseudo two-dimensional HMM (P2DHMM) which models two-dimensional data by using an outer HMM for the vertical direction whose states are themselves HMMs, modelling the horizontal direction. The strength of HMMs and therefore also P2DHMMs is their ability to compensate for signal ‘distortions’ like stretches and shifts. In the case of comparing an image of a face to a face model, such a distortion can arise if the face is turned away from the camera, is foreshortened, or if the face has been inaccurately detected and localised. To compare an image of a face with a face model, regions of the face are first identified in the image and then compared to the corresponding regions of the model, in a technique known as ‘alignment’ or ‘segmentation’.

An ‘average face model’, also called the ‘universal background model’ (UBM) or ‘stranger model’, is ‘built’ or trained using many images from many different people, e.g. 400 images from 100 people. The images used for training are preferably chosen to be a representative cross-section through all suitable types of faces. For a security system, for example, the average face model might be trained using faces of adults of any appropriate nationality. An archive searching system used to locate images of actors in a video archive might require an average face model based on images of people over a broader age group.

The average face model can be trained using known methods which apply an ‘expectation maximization’ algorithm, which is commonly used to estimate the probability density of a set of given data, in this case the facial features of an image. This method of training, also called ‘maximum likelihood’ (ML) training, is slow, requiring up to several hours to train the average face model, but this initial investment only needs to be carried out once. Once the average face model is trained, it can be utilised in any appropriate system for face recognition.

A ‘reference face model’ is used to model a particular face. For example, a reference face model might be used to model the face of a person permitted to gain access to a system. Such a reference face model is also trained using the method for training the average face model, but with much fewer images, where the images are all of that person's face. A system for face recognition preferably comprises a number of reference face models, at least one for each face, which it can identify. For example, a security system might have a database of reference face models, one for each of a number of employees who are to be permitted access to the system.

The images used to train the average face model and reference face model can be of any suitable image format, for example JPEG (Joint Photographic Experts Group), a standard commonly used for the compression of colour digital images, or some other suitable image format. The images can be obtained from an archive or generated with a camera expressly for the purpose of training. Equally, the test image of the person who is to be subjected to the identification procedure can also be obtained by means of a camera or video camera. An image obtained thus can be converted as necessary into a suitable electronic data format using an appropriate conversion tool. The test image is then processed to extract a matrix of local feature vectors, to derive a representation of the face in the test image that is invariant to the lighting conditions but still contains relevant information about the identity of the person.

To determine whether the test image can be matched to any of the reference face models, the test image is evaluated against each of the reference face models. First, the feature matrix of the test image is aligned to the average face model, which can be understood to be a type of mapping of the local facial features of the feature matrix to the states of the average model. To this end, an optimal path or alignment through the state sequences of the average face model is calculated for the feature matrix of the test image. This optimal path is commonly referred to as the ‘best path’. Usually the Viterbi algorithm is applied to find the best path efficiently. According to the method of the present invention, the best path is then applied to each of the reference face models of the face recognition system, and a ‘degree of similarity’ is efficiently computed for each reference model. In the simplest case, the degree of similarity is a score, which is calculated for a reference model when evaluating the test image against the reference face model. The score is an indication of how well the test image can be applied to the reference face model, e.g. the score might denote the production probability of the image given the reference model. For efficiency reasons, an approximate score is computed using the best path through the average model. A high degree of similarity for a reference face model indicates a relatively close match between the reference face model and the test image, whereas a low degree of similarity indicates only a poor match.

The most evident advantage of the method of performing face recognition according to the present invention is its successful exploitation of the similarity between face images to speed up the recognition process. The calculation of the best path, a cost-intensive process requiring the greater part of the entire computational effort, need only be computed once for the average face model and can then used to evaluate an image against each reference face model of a face recognition system. Therefore, using the method according to the present invention, it is not necessary to perform the cost-intensive best-path computations for each reference face model.

The quickest way to compute a degree of similarity is to apply the best path directly to a reference face model, so that it only remains to calculate the score. In a further embodiment of the invention, the best path of the average face model can first be modified or optimised for a particular reference face model, resulting in a somewhat greater computational effort, but a correspondingly more accurate score, thereby improving even further the accuracy of the face recognition system.

A relatively high score for a reference face model need not necessarily mean that that reference face model is an unequivocal match for the test image, since common lighting conditions also lead to higher scores because the features are usually not totally invariant to lighting conditions. However, the score on the average model will, in such a case, also generally be higher. Thus, the degree of similarity is preferably taken to be the ratio of the score for the reference face model to the score of the average face model. Therefore, in a preferred embodiment, a score is also calculated for the average face model, and the ratio of the highest reference face model score to the average face model score is computed. This ratio might then be compared to a threshold value. If the ratio is greater than the threshold value, the system may accept the corresponding reference face model, otherwise it should reject that reference face model. The fact that the reference model is derived from the average model using MAP parameter estimation supports the use of the ratio since the sensitivity of both models to the lighting conditions is similar.

The accuracy of state-of-the-art face recognition systems depends to some extent on a threshold level, used to decide whether to accept or reject a face model identified as most closely resembling the probe image. Face recognition systems to date use a single threshold value for all face models. If this threshold level is too high, a face model might be rejected, even if it is indeed the correct face model corresponding to the probe image. On the other hand, if the threshold level is too low, a face model unrelated to the probe image might incorrectly be accepted as the “correct” face model.

Therefore, in a particularly preferred embodiment of the invention, a unique similarity threshold value is assigned to each reference face model, improving the accuracy of the system's decision to accept or reject a reference face model.

A preferred method of calculating a similarity threshold value for a reference face model for use in a face recognition system comprises the steps of acquiring a reference face model based on a number of distinct images of the same face and acquiring a control group of unrelated face images. The reference face model is evaluated against each of the unrelated face images in the control group and an evaluation score is calculated for each of the unrelated face images. The evaluation scores are used to determine a similarity threshold value for this reference face model, which would cause a predefined majority of these unrelated face images to be rejected, were they to be evaluated against this reference face model.

The fixed threshold used by face recognition systems of the prior art can lead to incorrect decisions regarding the identification of a test image. The reason for this is that some faces resemble the average face model more closely than do other faces. Therefore, a test image of the face of such a person results in a high score when evaluated against the average face model. This in turn results in a low ratio of the score for the reference face model of that person's face to the average face model score. As a result, the reference face model for this person's face, and therefore this person, would be more likely to be rejected by such a system. Furthermore, a person whose face is very different from that of the average face model, but resembling to some extent one of the reference face models in a system, might erroneously be accepted.

These undesirable false rejection and false acceptance errors can be reduced to a minimum using the method described above for calculating a similarity threshold value for each reference face model in a face recognition system. To this end, each reference face model is evaluated against a control group of images. Each image is of a face different to that modelled by the reference face model, and the control group of images is preferably a representative selection of faces of varying similarity to the face modelled by the reference face model. An evaluation score is computed for each image of the control group, by finding the best path through an average face model and applying this best path to each of the images in the control group in order to evaluate each of them against the reference face model. The best path can also be applied to the reference face model to calculate its score. The scores of each of the images in the control group and the score of the reference face model can then be used to choose a threshold value that would ensure that, in a later face recognition procedure, a predefined majority—for example 99%—of these images would be rejected when evaluated against the reference face model.

Such a unique similarity threshold value may not only be used in the particular method of performing face recognition described above, but in any method of performing face recognition where in an identification procedure, a test image is evaluated against each of the reference face models, and the reference face model most closely resembling the test image is identified, and where the reference face model is subsequently accepted or rejected on the basis of the similarity threshold value of that reference face model, and therefore offers an independent contribution in addressing the underlying object of the invention.

An appropriate system for calculating a similarity threshold value for a reference face model for use in a face recognition system comprises a means for acquiring a reference face model based on a number of distinct images of the same face, and a means of acquiring a control group of unrelated face images. Furthermore, the system comprises an evaluation unit for evaluating the reference face model against each of the unrelated face images of the control group, and an evaluation score calculation unit for calculating an evaluation score for each of the unrelated face images. The system additionally comprises a similarity threshold value determination unit for determining a similarity threshold value for the reference face model on the basis of the evaluation scores, which would cause a predefined majority of these unrelated face images to be rejected were they to be evaluated against this reference face model.

Another characteristic of current approaches, resulting in slow and problematical face recognition, is that the effort required to train a model is quite large. The time invested in training a model is proportional to the number of images, yet it is desirable to use a relatively large number of images in training a model in order to obtain as great an accuracy as possible. Whenever a new image is introduced to further improve the accuracy of the model, the model must be retrained using all of the images. The entire process is therefore very slow, and accordingly expensive.

Therefore, preferably, a method of training a reference face model is used in the face recognition system, which method comprises the steps of acquiring an average face model based on a number of face images of different faces and acquiring a training image of the face for which the reference face model is to be trained. A training algorithm is applied to the average face model with the information obtained from the training image to give the reference face model.

The training image of the person which is to be used to train the reference face model for that person can be obtained, for example, by using a camera or video camera, or by scanning from a photograph, etc. The image can be converted as necessary into a suitable digital format such as those described above. Preferably, a number of training images are used to train the reference face model for the person, and all training images are of that person. A two-dimensional model, preferably a P2DHMM, is computed for each image using the method described above.

The training algorithm, preferably an algorithm using maximum a posteriori (MAP) techniques, uses a clone or copy of the average face model and adapts this to suit the face of the person by using a feature matrix generated for the training image. The adapted average face model becomes the reference face model for the person.

In a particularly preferred embodiment of the invention, a further training image of the person's face is used to refine or improve the reference face model. To this end, the training algorithm is applied to the old reference face model, the average face model, and the new training image to adapt the old reference model using any new image data. The new image data is thereby cumulatively added to the old reference face model.

Eventually, the reference face model will have reached a level, which cannot perceptibly be improved upon, so that it is not necessary to further refine it. Using the method of training a reference face model proposed herein, this level is generally attained after using about ten images of the person. Since new image data is cumulatively added, without having to train the reference face model using all the known images for this person, the training process is considerably faster than existing methods of training reference face models.

The average face model, trained using a selection of face images of different faces as described above, is preferably the same average face model used in the face recognition system. Therefore, the application of this training method together with the face recognition method according to the invention requires very little additional computational effort and is extremely advantageous. Furthermore, the training method can also be used independently with any other face recognition process, so that it offers an independent contribution in addressing the underlying object of the invention.

The average face model can be trained expressly for this system, or can be purchased from a supplier.

An appropriate system for training a reference face model comprises a means for acquiring an average face model and a means for acquiring a number of test images of the same face. Furthermore, the system comprises a reference face model generator for generating a reference face model from the training images, whereby the reference face model is based on the average face model.

Usually, images of faces, which are to be subject to an identification procedure, are not taken under ideal conditions. More generally, the lighting is less than perfect, with, for example, back lighting or strong lighting from the side, or poor lighting. These results in a face image, which might be subject to strong fluctuations in local intensity, for example one side of the face might be in relative shadow, while the other side is strongly illuminated. More importantly, different images of the same face can exhibit significant discrepancies in appearance, depending on the variation of the lighting conditions. Thus, a model trained from one image of a person may fail to achieve a high score on another image of the same person taken under different lighting conditions. Therefore, it is very important to transform the features into a form that is independent on the lighting conditions, otherwise, a test image of a person's face taken under less than ideal lighting conditions could result in a false rejection, or, perhaps even worse, a false acceptance.

To provide a more accurate face recognition, preferably a method of optimizing images is used in the face recognition process and/or training process, wherein the illumination intensity of an image is equalised by sub-dividing the image into smaller sub-images, preferably overlapping, calculating a feature vector for each sub-image, and modifying the feature vector of a sub-image by dividing each coefficient of that feature vector by a value representing the overall intensity of that sub-image. Normally, this value corresponds to the first coefficient of the feature vector. This first coefficient is then no longer required and can subsequently be discarded. Alternatively or additionally, the feature vector can be converted to a normalised vector.

In both of the methods proposed above, the feature vectors for each sub-image of the entire image are modified, or decorrelated, in order to remove the dependence on the local illumination intensity. Both techniques significantly improve the recognition performance.

These methods are not restricted for use with the method for face recognition according to the invention, but can also serve to improve face recognition accuracy in other, state of the art, face recognition systems and face model training systems, and therefore offer independent contributions in addressing the underlying object of the invention.

An appropriate system for optimizing an image for use in face recognition according to the methods proposed comprises a subdivision unit for sub-dividing the image into a number of sub-images, a feature vector determination unit for determining a local feature vector associated with each sub-image, and a feature vector modification unit for modifying the local feature vector associated with a sub-image by dividing each coefficient of that feature vector by a value representing the overall intensity of that sub-image, and/or by discarding a coefficient of the feature vector, and/or by converting that feature vector to a normalised vector.

Other objects and features of the present invention will become apparent from the following detailed descriptions considered in conjunction with the accompanying drawings. It is to be understood, however, that the drawings are designed solely for the purposes of illustration and not as a definition of the limits of the invention.

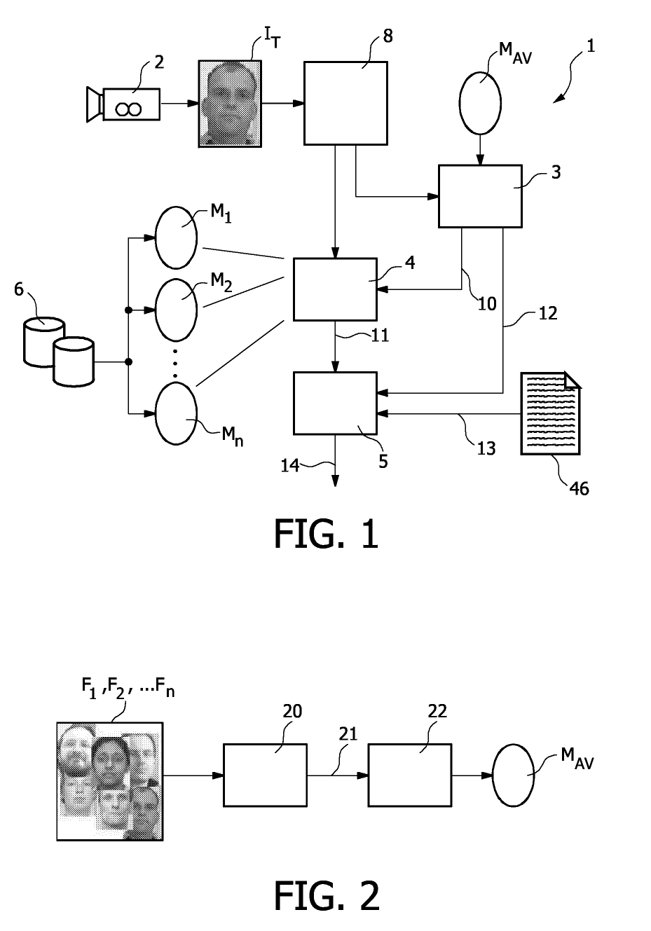

FIG. 1 is a block diagram of a system for performing face recognition;

FIG. 2 is a block diagram of a system for training an average face model for use in a face recognition system;

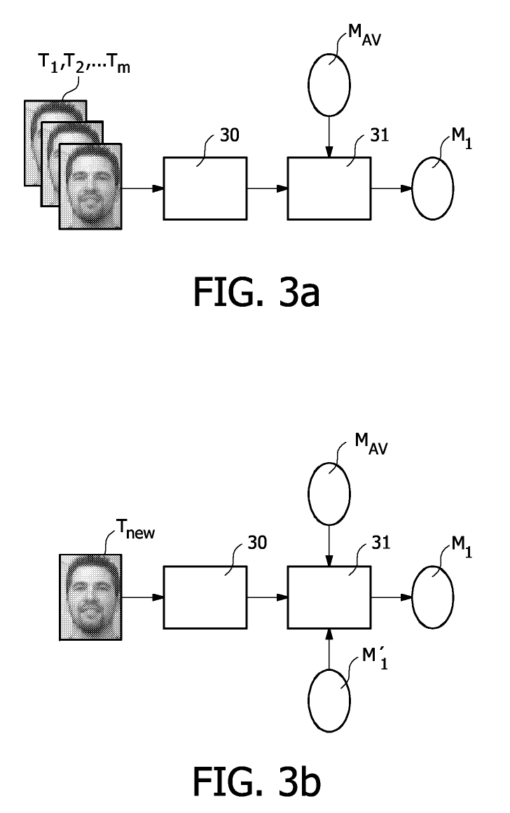

FIG. 3a is a block diagram of a system for training a reference face model for use in a face recognition system according to a first embodiment;

FIG. 3b is a block diagram of a system for training a reference face model for use in a face recognition system according to a second embodiment;

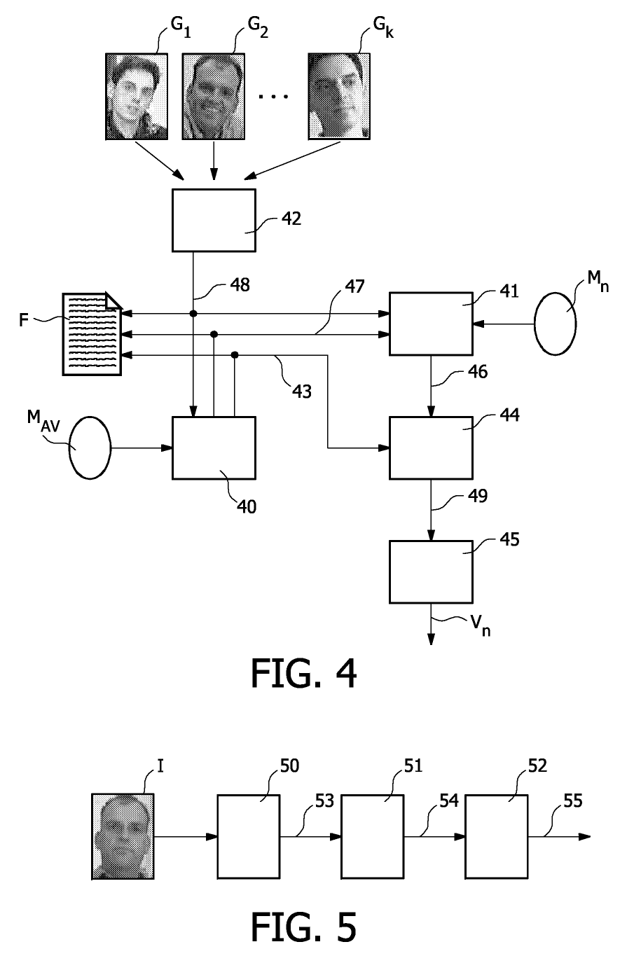

FIG. 4 is a block diagram showing a system for calculating a similarity threshold level for a reference face model;

FIG. 5 is a block diagram showing a system for optimizing images for use in face recognition.

In the drawings, like numbers refer to like objects throughout.

FIG. 1 shows the main blocks of a system for face recognition. An image acquisition unit 2, such as a camera, video camera or closed circuit TV camera is used to capture a test image I_{T} of the person to be identified. The image I_{T} is processed in an image processing block 8, in which a matrix of feature vectors, or feature matrix, is calculated for the image I_{T}, or simply extracted from the image I_{T}, according to the image type. Also in this processing block 8, the feature vectors may be optimised to compensate for any uneven lighting effects in the image I_{T} by modifying the feature vectors as appropriate. This modification or compensation step is described in more detail under FIG. 5.

Using the feature matrix, an optimal state sequence or best path 10 for the test image I_{T} is calculated through the average face model M_{AV} by applying the Viterbi algorithm in a method of alignment explained in the description above, in a best path calculation block 3. This best path 10 is then used in an evaluation unit 4 as a basis for calculating the degree of similarity, or score, for each of a number of reference face models M₁, M₂, . . . , Mₙ retrieved from a database 6.

The highest score 11 is passed to a decision making unit 5, as is the score 12 for the average face model. The ratio of these two scores 11, 12 is calculated and compared to a threshold value 13 read from a file. In this case, the threshold value 13 is the threshold value corresponding to the reference face model, which attained the highest score 11 in evaluation against the test image I_{T}. The manner in which such a threshold value can be obtained is described in detail in FIG. 4.

The output 14 of the decision-making unit 5 depends on the result of the comparison. If the ratio of the two scores 11, 12 falls below the threshold value 13, then even the closet fitting reference face model has failed, i.e. the system must conclude that the person whose face has been captured in the test image I_{T} cannot be identified from among the reference face models in its database 6. In this case the output 14 might be a message to indicate identification failure. If the system is a security system, the person would be denied access. If the system is an archive searching system, it might report that the test image I_{T} has not been located in the archive.

If the comparison has been successful, i.e. the ratio of the two scores 11, 12 lies above the threshold value 13, then that reference face model can be taken to match the person whose test image I_{T} is undergoing the face recognition process. In this case, the person might be granted access to the system, or the system reports a successful search result, as appropriate.

FIG. 2 illustrates the creation of an average face model M_{AV} for use in the face recognition system described above. A collection of unrelated face images F₁, F₂, . . . , Fₙ from a number of different people, which should be as diverse as possible and a representative cross-section of all faces, is acquired. These images F₁, F₂, . . . , Fₙ may be purchased from a supplier, or generated expressly for the training process. In an image processing unit 20, described in more detail under FIG. 5, a set of feature vectors 21, or feature vector matrix, is calculated for or extracted from the image, F₁, F₂, . . . , Fₙ as necessary, and forwarded to a training unit 22.

In the training unit 22, a method of training is applied to the processed feature vectors 21 of each image F₁, F₂, . . . , Fₙ. In this case, the training method uses the expectation maximization (EM) algorithm following a maximum likelihood (ML) criterion to find the model parameters for the average face model M_{AV}. The average face model M_{AV}, as a pseudo 2-dimensional Hidden Markov Model (P2DHMM), describes the general likelihood of each of the local features of a face. Faces with ‘average’ facial features will achieve a higher score than faces exhibiting more unusual facial features. A face image taken under common lighting situations will also achieve a higher score. The number of face images F₁, F₂, . . . , Fₙ in the collection is chosen to give a satisfactory average face model M_{AV}.

FIG. 3a shows a system for training a reference face model M₁, preferably for use in the above mentioned face recognition system, for a particular person. Here, the training system is supplied with a number of training images T₁, T₂, . . . , Tₘ, all of that person's face. In an image processing unit 31, a feature vector matrix is derived from each training image T₁, T₂, . . . , Tₘ. To improve the quality of the reference face model M₁ being created, the feature vectors for each training image T₁, T₂, . . . , Tₘ can be first processed in the image processing unit 30, in a manner described in more detail under FIG. 5, to compensate for any uneven illumination effects.

A copy or clone of the average face model M_{AV} is used, along with the information obtained from the training images T₁, T₂, . . . , Tₘ, as input to a reference face model generator 31. In the reference face model generator 31, the average face model M_{AV} is used as a starting point, and is modified using information extracted from the images T₁, T₂, . . . , Tₘ under application of maximum a posteriori (MAP) parameter estimation in order to arrive at a reference face model M₁ for the face depicted in the training images T₁, T₂, . . . , Tₘ. The initial training of a person's reference face model M₁ can take effect using a minimum of one image of that person's face, but evidently a greater number of images will give a better reference face model M₁. One method of MAP parameter estimation for P2DHMM whose states are Gaussian mixtures is the following: the best path through the average model is computed for each training image. The feature vectors (also referred to as “features” in the following) are then assigned to the states of the P2DHMM according to the best path. Each feature assigned to a Gaussian mixture is then assigned to the closest Gaussian of the mixture. The mean of the Gaussian is set to a weighted average of the average model's mean and the mean of the features. The reference model has thus been altered to give a better representation of the appearance of the person in the training image. Other parameters of the P2DHMM can be altered in a similar manner, or can simply be copied from the average model, since the means are the most important parameters. The sum of the features—which was computed to estimate the mean of the features—and the total number, or count, of the features are stored with the Gaussian to enable the incremental training described below.

The reference face model M₁ for a person can be further improved by refining it using additional image data T_{new} of that person's face. In FIG. 3b, a further training image T_{new} has been acquired for the person. The new training image T_{new} is first processed in an image-processing unit 30 as described under FIG. 3a above. Image information from the new training image T_{new}, along with the average face model M_{AV} and a copy M₁′ of the reference face model for this person, is input to the reference face model generator 31, in which MAP parameter estimation is applied to the old and new data to give an improved reference face model M₁ for this person. When using a P2DHMM whose states are Gaussian mixtures, the incremental MAP training can be implemented in the following way: the features of the new training images are assigned to the Gaussians as described above, where the average model is used for the assignment. The mean of the reference model's Gaussian has to be set to a weighted average of the average model's mean and the mean of all training features. The mean of all training features is easily computed since the sum and the count of the old features are stored along with the Gaussian. The sum and the count are updated by including the new features to enable further training sessions. Thus the same reference model will result, no matter in which order the training images arrive.

To improve the accuracy of the decision whether to accept or reject the reference face model identified as the closest match to the test image, each reference face model M₁, M₂, . . . , Mₙ of a face recognition database can be supplied with its own specific similarity threshold value. FIG. 4 shows a system for generating a unique similarity threshold value for a reference face model Mₙ. An existing reference face model Mₙ for a particular person is acquired. A control group of unrelated face images G₁, G₂, . . . Gₖ is also acquired. These images G₁, G₂, . . . Gₖ are chosen as a representative selection of faces of varying degrees of similarity to the person modelled by the reference face model Mₙ. The images are first processed in an image-processing unit 42, described in more detail under FIG. 5, to extract a feature matrix 48 for each image.

In a best path calculation unit 40, the best path 47 is calculated through the average face model M_{AV} for each image the score 43 on the average model M_{AV} is also computed. The feature matrices 48, scores 43 and best paths 47 only have to get computed once since the average model never changes, and can be saved in a file F for later use. Unit 44 computes the degrees of similarity 49 from the reference model's scores and the average model's scores. The similarity threshold determination unit 45 requires the degrees of similarity 49 for all control group images G₁, G₂, . . . Gₖ to find a threshold value Vₙ that will result in the rejection of the majority of the control group images G₁, G₂, . . . Gₖ, when compared to the reference model Mₙ. The scores 43 for the reference model Mₙ are supplied by unit 41 which requires the best paths 47 and the feature matrices 48 of the control group images as well as those of the reference model Mₙ. The computationally expensive part is the computation of the best path 47 through the average model M_{AV}. However, this step can be performed offline, whereas the actual calibration is very fast and can be performed online directly after training the reference face model Mₙ.

Any image used for face recognition, for training the average face model, for training a reference face model and for calculating a similarity threshold value for a reference face model can be optimised before use to transform it into a representation that is invariant to the illumination settings. FIG. 5 shows components of a system for image optimization, which can be used as the image processing units 8, 20, 30, 42 mentioned in the previous figure descriptions.

An image I is input to an image subdivision unit 50, which divides the image into smaller, overlapping sub-images. Allowing the sub-images to overlap to some extent improves the overall accuracy of a model, which will eventually be derived from the input image. The sub-images 53 are forwarded to a feature vector determination unit 51, which computes a local feature vector 54 for each sub-image 53. A possible method of computing the local features is to apply the discrete cosine transformation on the local sub-image and extract a sub set of the frequency coefficients. The illumination intensity of each sub-image 53 is then equalised by modifying its local feature vector 54 in a feature vector modification unit 52. This can be done by dividing each coefficient of the local feature vector 54 by a value representing the overall intensity of that sub-image, by discarding the first coefficient of the local feature vector 54, by normalising the local feature vector 54 to give a unit vector, or by a combination of these techniques. The output of the feature vector modification unit 52 is thus a matrix 55 of decorrelated local feature vectors describing the input image I.

This feature vector matrix is 55 used in the systems for training face models, for face recognition, and for similarity threshold value calculation, as described above.

Although the present invention has been disclosed in the form of preferred embodiments and variations thereon, it will be understood that numerous additional modifications and variations could be made thereto without departing from the scope of the invention. In particular, the methods for face recognition, for training a reference face model, for optimizing images for use in a face recognition system, and for calculating similarity threshold values, and therefore also the corresponding systems for face recognition, for training a reference face model, for calculating a similarity threshold value for a reference face model, and for optimising an image for use in a face recognition system can be utilised in any suitable combination, even together with state-of-the-art face recognition systems ad training methods and systems, so that these combinations also underlie the scope of the invention.

For the sake of clarity, it is also to be understood that the use of “a” or “an” throughout this application does not exclude a plurality, and “comprising” does not exclude other steps or elements. A “unit” may comprise a number of blocks or devices, unless explicitly described as a single entity.

1. A method of performing face recognition, which method comprises the steps of
generating an average face model (M_{AV})—comprising a matrix of states representing regions of the face—from a number of distinct face images (I₁, I₂, . . . Iⱼ);
training a reference face model (M₁, M₂, . . . , Mₙ) for each one of a number of known faces, where the reference face model (M₁, M₂, . . . , Mₙ) is based on the average face model (M_{AV});
acquiring a test image (I_{T}) for a face to be identified;
calculating a best path through the average face model (M_{AV}) based on the test image (I_{T});
evaluating a degree of similarity for each reference face model (M₁, M₂, . . . , Mₙ) against the test image (I_{T}) by applying the best path of the average face model (M_{AV}) to each reference face model (M₁, M₂, . . . . , Mₙ);
identifying the reference face model (M₁, M₂, . . . . , Mₙ) most similar to the test image (I_{T});
accepting or rejecting the identified reference face model (M₁, M₂, . . . , Mₙ) on the basis of the degree of similarity.

2. A method according to claim 1, wherein the best path through the average face model (M_{AV}) is optimised with respect to a reference face model (M₁, M₂, . . . , Mₙ) for evaluation of the degree of similarity for that reference face model (M₁, M₂, . . . , Mₙ) against the test image (I_{T}).

3. A method according to claim 1, wherein the step of evaluating a degree of similarity between a reference face model (M₁, M₂, . . . , Mₙ) and a test image (I_{T}) comprises applying the best path of the average face model (M_{AV}) to the reference face model (M₁, M₂, . . . , Mₙ) to calculate a reference face model score for that test image (I_{T}), calculating the average face model score for that test image (I_{T}), and obtaining the degree of similarity in the form of the ratio of the reference face model score to the average face model score and wherein the step of accepting or rejecting the identified reference face model (M₁, M₂, . . . , Mₙ) comprises comparing the degree of similarity to a predefined similarity threshold value.

4. A method according to claim 3, wherein a unique similarity threshold value is used for each reference face model (M₁, M₂, . . . , Mₙ) in making the decision to accept or reject the identified reference model (M₁, M₂, . . . , Mₙ).

5. A method of training a reference face model (M₁) for use in a face recognition system, comprising the steps of
acquiring an average face model (M_{AV}) based on a number of face images (I₁, I₂, . . . Iⱼ) of different faces;
acquiring a number of test image (T₁, T₂, . . . , Tₘ) of the face for which the reference face model (M₁) is to be trained;
applying a training algorithm to the average face model and information obtained from the test images (T₁, T₂, . . . , Tₘ) to give the reference face model (M₁).

6. A method according to claim 5, wherein the reference face model (M₁) is improved by applying the training algorithm to the average face model (M_{AV}), information obtained from a further test image (T_{new}) of the same face and a copy of the reference model (M₁′) to give an improved reference model (M₁).

7. A method of calculating a similarity threshold value for a reference face model (Mₙ) for use in a face recognition system, which method comprises the steps of
acquiring a reference face model (Mₙ) based on a number of distinct images of the same face;
acquiring a control group of unrelated face images (G₁, G₂, . . . Gⱼ);
evaluating the reference face model (Mₙ) against each of the unrelated face images (G₁, G₂, . . . Gⱼ) in the control group;
calculating an evaluation score for each of the unrelated face images (G₁, G₂, . . . Gⱼ);
using the evaluation scores to determine a similarity threshold value for this reference face model (Mₙ) which would cause a predefined majority of these unrelated face images (G₁, G₂, . . . Gⱼ) to be rejected were they to be evaluated against this reference face model (Mₙ).

8. A method of performing face recognition, which method comprises the steps of
acquiring a number of reference face models (M₁, M₂, . . . , Mₙ) for a number of different faces, where each reference face model (M₁, M₂, . . . , Mₙ) is based on a number of distinct images of the same face;
determining a similarity threshold value for each reference face model (M₁, M₂, . . . , Mₙ) using the method according to claim 7;
acquiring a test image (I_{T});
identifying the reference face model (M₁, M₂, . . . , Mₙ) most similar to the test image (I_{T});
accepting or rejecting the identified reference face model (M₁, M₂, . . . , Mₙ) on the basis of the similarity threshold value.

9. A method of performing face recognition according to claim 1, wherein the reference face models (M₁, M₂, . . . , Mₙ) are trained using a method of training a reference face model (M₁) for use in a face recognition system, comprising the steps of
acquiring an average face model (M_{AV}) based on a number of face image (I₁, I₂, . . . Iⱼ) of different faces;
acquiring a number of test image (T₁, T₂, . . . , Tₘ) of the face for which the reference face model (M₁) is to be trained;
applying a training algorithm to the average face model and information obtained from the test images (T₁, T₂, . . . , Tₘ) to give the reference face model (M₁).

10. A method of optimizing an image (I) for use in face recognition, wherein the illumination intensity of the image (I) is equalised by sub-dividing the image (I) into smaller sub-images, calculating a feature vector for each sub-image, and modifying the feature vector of a sub-image by dividing each coefficient of that feature vector by a value representing the overall intensity of that sub-image, and/or by discarding a coefficient of the feature vector, and/or by converting that feature vector to a normalised vector.

11. A method of performing face recognition according to claim 1, wherein the images (I, I_{T}, I_{T}, G₁, G₂, . . . . Gⱼ, T₁, T₂, . . . , Tₘ, T_{new}) used for training reference face models (M₁, M₂, . . . , Mₙ) and/or for face recognition are first optimized according to the method of optimizing an image (I) for use in face recognition, wherein the illumination intensity of the image (I) is equalised by sub-dividing the image (I) into smaller sub-images, calculating a feature vector for each sub-image, and modifying the feature vector of a sub-image by dividing each coefficient of that feature vector by a value representing the overall intensity of that sub-image, and/or by discarding a coefficient of the feature vector, and/or by converting that feature vector to a normalised vector.

12. A system (1) for performing face recognition, comprising
a number of reference face models (M₁, M₂, . . . , Mₙ) and an average face model (M_{AV}) where each face model (M₁, M₂, . . . , Mₙ, M_{AV}) comprises a matrix of states representing regions of the face;
an acquisition unit (2) for acquiring a test image (I_{T});
a best path calculator (3) for calculating a best path through the average face model (M_{AV});
an evaluation unit (4) for applying the best path of the average face model (M_{AV}) to each reference face model (M₁, M₂, . . . , Mₙ) in order to evaluate a degree of similarity between each reference face model (M₁, M₂, . . . , Mₙ) and the test image (I_{T});
a decision making unit (5) for accepting or rejecting the reference face model (M₁, M₂, . . . , Mₙ) with the greatest degree of similarity.

13. A system for training a reference face model (M_{R}) comprising
a means for acquiring an average face model (M_{AV});
a means for acquiring a number of training images (T₁, T₂, . . . , Tₙ) of the same face;
and a reference face model generator (22) for generating a reference face model (M₁) from the training images (T₁, T₂, . . . , Tₙ), whereby the reference face model (M₁) is based on the average face model (M_{AV}).

14. A system for calculating a similarity threshold value for a reference face model (Mₙ) for use in a face recognition system comprising
a means for acquiring a reference face model (Mₙ) based on a number of distinct images of the same face;
a means of acquiring a control group of unrelated face images (G₁, G₂, . . . Gₖ);
an evaluation unit (41) for evaluating the reference face model (Mₙ) against each of the unrelated face images (G₁, G₂, . . . Gₖ) of the control group;
an evaluation score calculation unit (40) for calculating an evaluation score for each of the unrelated face images (G₁, G₂, . . . Gₖ);
a similarity threshold value determination unit (45) for determining a similarity threshold value for the reference face model (Mₙ), on the basis of the evaluation scores, which would cause a predefined majority of these unrelated face images (G₁, G₂, . . . Gₖ) to be rejected were they to be evaluated against this reference face model (Mₙ).

15. A system for optimizing an image (I) for use in face recognition, comprising
a subdivision unit (50) for sub-dividing the image (I) into number of sub-images;
a feature vector determination unit (51) for determining a local feature vector associated with each sub-image;
a feature vector modification unit (52) for modifying the local feature vector associated with a sub-image by dividing each coefficient of that local feature vector by a value representing the overall intensity of that sub-image, and/or by discarding a coefficient of the feature vector, and/or by converting that local feature vector to a normalised vector.

16. A system for performing face recognition, comprising a system for training a reference face model (M_{R}) according to claim 13.
